(19) United States
(12) Patent Application Publication
(10) Pub. No.: US 2002/0091764 A1
(43) Pub. Date: Jul. 11, 2002

(54) System and method for processing and managing self-directed, customized video streaming data

(76) Inventor: Burton Allen Yale, Yorba Linda, CA (US)

Correspondence Address: IRELL & MANELLA LLP, 840 NEWPORT CENTER DRIVE, SUITE 400, NEWPORT BEACH, CA, 92660, US

(21) Appl. No.: 09/963,265

(22) Filed: Sep. 25, 2001

Related U.S. Application Data
(60) Provisional application No. 60/235,191, filed on Sep. 25, 2000.

(51) Int. Cl. G09G 5/00; G06F 15/16; G06F 17/60; H04N 7/173

(52) U.S. Cl. 709/203; 705/14; 725/87; 345/745

(57) ABSTRACT

A method for delivering listing-specific multimedia to users visiting online directories through the use of a multimedia icon. Users searching online directories can select to view multimedia information associated with individual directory entries by clicking on an icon which serves as a hypertext link to the selected multimedia content. Users are also provided with options for selecting their preferred file format for viewing the selected multimedia information such that the -multimedia information may be provided to the user in a specific commercial multimedia player format, including, but not limited to, QuickTime, RealMedia and Windows Media Player.

### REFERENCE TO PRIOR APPLICATION

This application is based on U.S. Provisional application No. 60/235,191, filed on Sep. 25, 2000.

### BACKGROUND OF THE INVENTION

1. Field of the Invention

The present invention relates in general to the processing of information, and more particularly, to a system and method for producing and processing video for streaming over a network.

2. Background

Traditionally, consumers would search for merchants, service providers and other businesses through printed directories, such as phonebooks, trade magazines, and local business directories. Of course, this form of searching has always been limited by the amount of information available. Even an advertising-based directory such as the Yellow Pages contains little to no information about the nature and scope of the business in question.

Today, consumers are able to search a myriad of directories in an online environment, ranging from general directories such as the online Yellow Pages, to specialty directories like Boats-Yatchs.com and PGA.com. However, such directories suffer from the same limitations as those in the print media. This fact handicaps the ability of a consumer from obtaining information which would otherwise be valuable in the service or product shopping process.

While television and other forms of video advertising have the ability to convey much more information about a product or service, it too has significant limitations. For one, television advertising is not targeted, meaning that consumers are often forced to sit through advertisements which bear little or no relation to the interests of the viewer. Second, television advertising faces intense time pressures due to the high cost of television advertisement. Moreover, television advertising suffers from the fact that it forces consumers to digest information at a time other than when they may be interested in receiving such information, thus cutting into the target audience's attention span. Yet another drawback to traditional television advertising has been the cumbersome and expensive process of developing and producing video-based marketing material.

### SUMMARY OF THE INVENTION

The present invention is a system and method for providing multimedia content to a user on a user computer over a network. The method comprises associating the multimedia content with a directory entry using an icon corresponding to the directory entry, where the directory entry is to be included in a plurality of directories that are accessible over said network, and displaying said directory entry and said icon on said user computer when accessing one of said plurality of directories over the network. The method further comprises determining if the user has indicated a preferred file format, and if not, requesting that the user indicate the preferred file format. The method also comprises providing said multimedia content on the user computer in response to the user selecting said icon, said multimedia content to be provided to the user in the preferred file format.

Other embodiments are described herein.

### BRIEF DESCRIPTION OF THE DRAWINGS

FIG. 1 illustrates a system block diagram of one embodiment of a network system in which the system and methods of the invention are used.

FIG. 2 illustrates a block diagram of a computer system, according to one embodiment of the present invention.

FIG. 3A illustrates a display page 310 depicting an online directory containing graphics portions 320, a listings portion 330 and 300-301_{N} to streaming video, according to one embodiment of the present invention.

FIG. 3B illustrates the display page of FIG. 3A after a user has selected an active streaming video link, according to one embodiment of the present invention.

FIG. 3C illustrates the display page of FIG. 3A after a user has selected one of the commercially available video streamers, according to one embodiment of the present invention.

FIG. 4A illustrates a display page after a user has selected an inactive streaming video link, according to one embodiment of the present invention.

FIG. 4B illustrates the graphical user interface after the user has selected an inactive streaming video link, according to yet another embodiment of the present invention.

FIG. 5A illustrates a block/flow diagram for the process of viewing streaming video, according to one embodiment of the present invention.

FIG. 5B illustrates a block/flow diagram for the process of viewing streaming video, according to yet another embodiment of the present invention.

FIG. 6 illustrates a block/flow diagram for the process of creating and making available streaming video, according to one embodiment of the present invention.

### DETAILED DESCRIPTION

One aspect of the present invention seeks to combine the informational advantage of video-based advertising and marketing, with the targeted, self-directed searching capability of online directories, while dispensing with many of the expensive and cumbersome video production obstacles normally associated with video production.

Another aspect of the invention involves a process for delivering listing-specific videos to users visiting online directories. In one embodiment, developer obtains the right to place an icon or indicia, corresponding to an entry, in an online directory. Upon visiting any online directory subscribing to the video linking service, a user can click on an inactive icon, or in one embodiment click on an inactive V-Button, and instantly begin the process for having a marketing or informational video created, produced, and linked to their listing entry.

In one embodiment, the user submits a digitized video clip over the network system to developer. In another embodiment, the user submits a video clip on magnetized tape, such as VHS, for conversion into a digitized format by developer. In yet another embodiment, developer both creates the video clip as well as digitizes it. Once the directory entry is linked to the video linking service, any user subsequently navigating through the online directory who encounters the given entry will have access to the created video clip via the video icon.

Yet another aspect of the invention relates to the process for streaming video to a user in the format of the user's choice. In one embodiment, upon clicking an active streaming video link, software on the developer's server capable of detecting the user's history will determine if the user has previously indicated a preference for a particular electronic media player. If so, only this streamer is presented to the user. If no such history is found, software on the developer's server will present the user with several media players from which to choose. Once a user makes a choice this information is stored and used for subsequent video streaming requests by the user.

### Definitions

As discussed herein, a “computer” or “computer system” is a product including circuitry capable of processing data. The computer system may include, but is not limited to, a general purpose computer systems (e.g., server, laptop, desktop, palmtop, etc.), personal electronic devices (e.g., palm pilot), office equipment, banking equipment (e.g., an automated teller machine), electronic devices (e.g., CD/DVD player, receiver/tuner, television, etc.), cash registers, networked devices and appliances, and the like. A “communication link” generally refers to the medium or channel of communication over which information may be transferred. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof. A module may be implemented in software and/or hardware.

System Overview

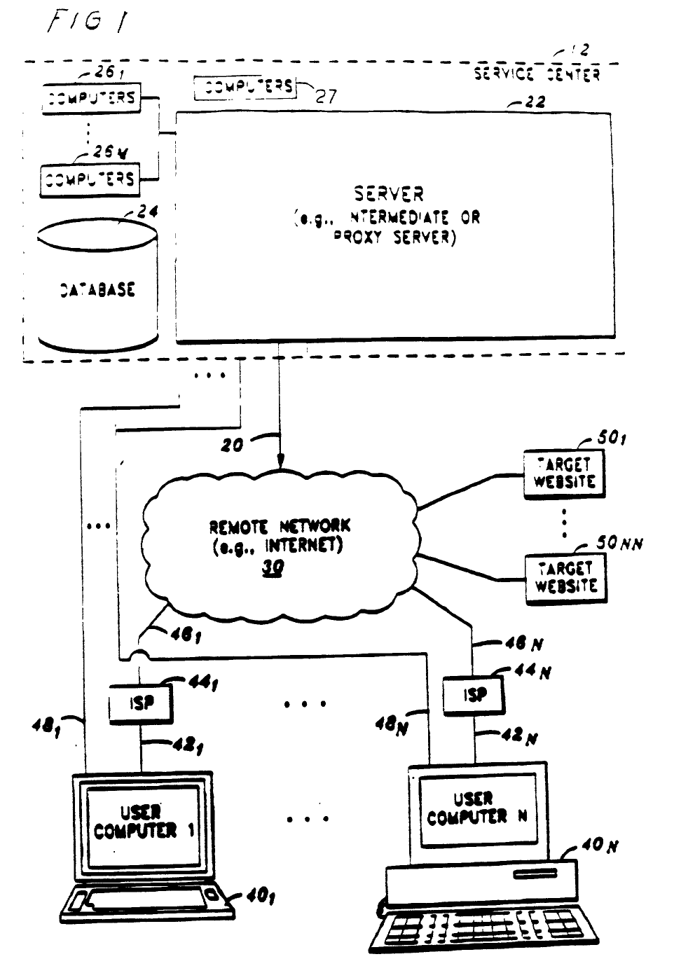

A description of an exemplary system, which incorporates embodiments of the present invention, is herein described. FIG. 1 shows a system block diagram of one embodiment of a network system 10 in which the system and methods of the invention are used. Referring to FIG. 1, the network system 10 comprises a service center 12 that is connected over one or more communication links 20 to a remote network 30 (e.g., a wide area network or the Internet) or a remote site (e.g., a satellite, which is not shown in FIG. 1) to one or more user computer systems 40₁-40_{N} (“40”). In one embodiment, the service center 12 is the developer's Website. The service center 12 includes one or more servers 22 and one or more databases 24. In one embodiment, the server 22 includes software modules for performing the processes of the invention, as described in detail in the following sections.

The server 22 may be connected to one or more computers 26₁-26_{M}. If a plurality of computers are used, then the computers 26₁-26_{M} may be connected by a local area network (LAN) or any other similar connection technology. However, it is also possible for the service center 12 to have other configurations. For example, a smaller number of larger computers (i.e. a few mainframe, mini, etc. computers) with a number of internal programs or processes running on the larger computers capable of establishing communication links to the user computers.

In one embodiment, computers 26₁-26_{M} can be remote from server 22, as is the case with computer 27. Computers 26₁-26_{M} and/or computer 27 can be used to perform the video editing, compressing and encoding for ultimate storage in the one or more databases 24, on the server 22, or on the one or more computers 26₁-26_{M} and/or computer 27.

The remote network 30 or remote site allows the service center 12 to provide video, information and other services to the user computers 40₁-40_{N}, using software and data that is stored at the service center 12. The one or more databases 24 connected to the service center computer(s), e.g., computer 26₁, are used to store data such as video files, encoding software, and any other data appropriate for carrying out the present invention. Each user computer 40₁-40_{N} is connected over a corresponding communication link 42₁-42_{N} such as a local carrier exchange to a respective ISP 44₁-44_{N}, through which access to the remote network 30 is made. By inputting the URL address of the target Website with which the user desires to interact, the user may be connected to various target Websites, such as Websites 50₁-50_{NN}. In one embodiment, target Websites 50₁-50_{NN} are online directories containing entries and video icons 300-301_{N} as discussed in more detail below. In another embodiment, Websites 50₁-50_{NN} are sites containing links to video files located on server 22 or databases 24.

In an alternate embodiment, each user may be connected over a corresponding communication link 48₁-48_{N} to the service center 12, which provides network access and service to the Websites 50₁-50_{NN}. In a further embodiment, the display screen for viewing the video streaming presentation that implements the invention may be located on a television coupled to the network 30. For example, the end user may be a viewer of a set top box television. In this case, navigation through the graphical user interface may be provided through the use of control buttons on a remote control unit for controlling viewing of the television, or by other means known in the art.

One aspect of the present invention relates to the development of software for implementing the video streaming service/Website according to one or more embodiments of the present invention. Such a development process may occur on a computer system that is separate and apart from the service center 12, or may be developed using one of the computers 26₁-26_{M}. Alternatively, the development process may occur on a computer that is not coupled to the communication network. Upon completion of the development process, the code may be stored in the database 24. Alternatively, the code may be stored on a machine-readable medium, such as a diskette, CD or DVD. In one embodiment, the service center 12 that is connected over one or more communication links to a remote network (such as the internet) may be requested to provide the code for use on a client Website. In this embodiment, the code is stored on the database 24. Alternatively, the code may be provided on a machine-readable medium such as a diskette, a CD or DVD, for use by a client to enhance his/her website.

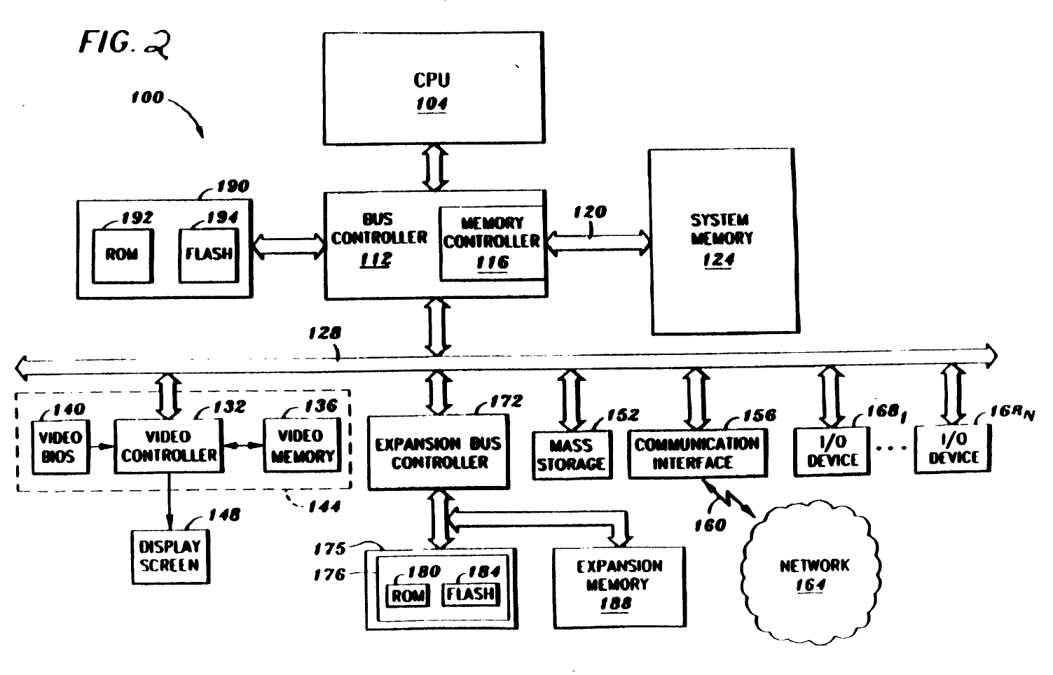

Referring to FIG. 2, the computer system 100 (e.g., computer 26 or 40) comprises a processor or a central processing unit (CPU) 104. The illustrated CPU 104 includes an Arithmetic Logic Unit (ALU) for performing computations, a collection of registers for temporary storage of data and instructions, and a control unit for controlling operation for the system 100. In one embodiment, the CPU 104 includes any one of the x86, Pentium™, Pentium II™, and Pentium Pro™ microprocessors as marketed by Intel™ Corporation, the K-6 microprocessor as marketed by AMD™, or the 6×86 MX microprocessor as marketed by Cyrix™ Corp. Further examples include the Alpha™ processor as marketed by Digital Equipment Corporation™, the 680×0 processor as marketed by Motorola™; or the Power PC™ processor as marketed by IBM™. In addition, any of a variety of other processors, including those from Sun Microsystems, MIPS, IBM, Motorola, NEC, Cyrix, AMD, Nexgen and others may be used for implementing CPU 104. The CPU 104 is not limited to microprocessor but may take on other forms such as microcontrollers, digital signal processors, reduced instruction set computers (RISC), application specific integrated circuits, and the like. Although shown with one CPU 104, computer system 100 may alternatively include multiple processing units.

The CPU 104 is coupled to a bus controller 112 by way of a CPU bus 108. The bus controller 112 includes a memory controller 116 integrated therein, though the memory controller 116 may be external to the bus controller 112. The memory controller 116 provides an interface for access by the CPU 104 or other devices to system memory 124 via memory bus 120. In one embodiment, the system memory 124 includes synchronous dynamic random access memory (SDRAM). System memory 124 may optionally include any additional or alternative high speed memory device or memory circuitry. The bus controller 112 is coupled to a system bus 128 that maybe a peripheral component interconnect (PCI) bus, Industry Standard Architecture (ISA) bus, etc. Coupled to the system bus 128 are a graphics controller, a graphics engine or a video controller 132, a mass storage device 152, a communication interface device 156, one or more input/output (I/O) devices 168₁-168_{N}, and an expansion bus controller 172. The video controller 132 is coupled to a video memory 136 (e.g., 8 Megabytes) and video BIOS 140, all of which may be integrated onto a single card or device, as designated by numeral 144. The video memory 136 is used to contain display data for displaying information on the display screen 148, and the video BIOS 140 includes code and video services for controlling the video controller 132. In another embodiment, the video controller 132 is coupled to the CPU 104 through an Advanced Graphics Port (AGP) bus.

The mass storage device 152 includes (but is not limited to) a hard disk, floppy disk, CD-ROM, DVD-ROM, tape, high density floppy, high capacity removable media, low capacity removable media, solid state memory device, etc., and combinations thereof. The mass storage device 152 may include any other mass storage medium. The communication interface device 156 includes a network card, a modem interface, etc. for accessing network 164 via communications link 160. The I/O devices 168₁-168_{N} include a keyboard, mouse, audio/sound card, printer, and the like. The I/O devices 168₁-168_{N} may be a disk drive, such as a compact disk drive, a digital disk drive, a tape drive, a zip drive, a jazz drive, a digital video disk (DVD) drive, a magneto-optical disk drive, a high density floppy drive, a high capacity removable media drive, a low capacity media device, and/or any combination thereof. The expansion bus controller 172 is coupled to non-volatile memory 175, which includes system firmware 176. The system firmware 176 includes system BIOS 82, which is for controlling, among other things, hardware devices in the computer system 100. The system firmware 176 also includes ROM 180 and flash (or EEPROM) 184. The expansion bus controller 172 is also coupled to expansion memory 188 having RAM, ROM, and/or flash memory (not shown). The system 100 may additionally include a memory module 190 that is coupled to the bus controller 112. In one embodiment, the memory module 190 comprises a ROM 192 and flash (or EEPROM) 194.

As is familiar to those skilled in the art, the computer system 100 further includes an operating system (OS) and at least one application program, which in one embodiment, are loaded into system memory 124 from mass storage device 152 and launched after POST. The OS may include any type of OS including, but not limited or restricted to, DOS, Windows™ (e.g., Windows 95™, Windows 98™, Windows N™), Unix, Linux, OS/2, OS/9, Xenix, etc. The operating system is a set of one or more programs which control the computer system's operation and the allocation of resources. The application program is a set of one or more software programs that performs a task desired by the user.

In accordance with the practices of persons skilled in the art of computer programming, the present invention is described below with reference to symbolic representations of operations that are performed by computer system 100, unless indicated otherwise. Such operations are sometimes referred to as being computer-executed. It will be appreciated that operations that are symbolically represented include the manipulation by CPU 104 of electrical signals representing data bits and the maintenance of data bits at memory locations in system memory 124, as well as other processing of signals. The memory locations where data bits are maintained are physical locations that have particular electrical, magnetic, optical, or organic properties corresponding to the data bits.

When implemented in software, the elements of the present invention are essentially the code segments to perform the necessary tasks. The program or code segments can be stored in a processor readable medium or transmitted by a computer data signal embodied in a carrier wave over a transmission medium or communication link. The “processor readable medium” or “machine-readable medium” may include any medium that can store or transfer information. Examples of the processor readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

As discussed earlier, upon completion of the software and/or graphical user interface development process, which in one embodiment includes the creation of video files capable of being streamed over the network, the corresponding code may be stored in the database 24 or on a machine-readable medium. The code may then be made available to users, such as those located at user computer 1-N (i.e., computers 40₁-40_{N}), through service center 12 or by means of the machine-readable medium. If the software or graphical user interface is presented via the machine-readable medium, the computers 40₁-40_{N} may not necessarily be linked to the remote network for purposes of using the invention.

For present discussion purposes, a discussion of the viewing process will be described in the following sections. In particular, after a user computer system 40 establishes a two-way communication link with target Website 50, which in one embodiment is an online directory containing various listings, the user is able to identify and view streaming media upon being directed to developer's service center 12 or upon communication with service center 12 directly.

### EXEMPLARY EMBODIMENTS

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

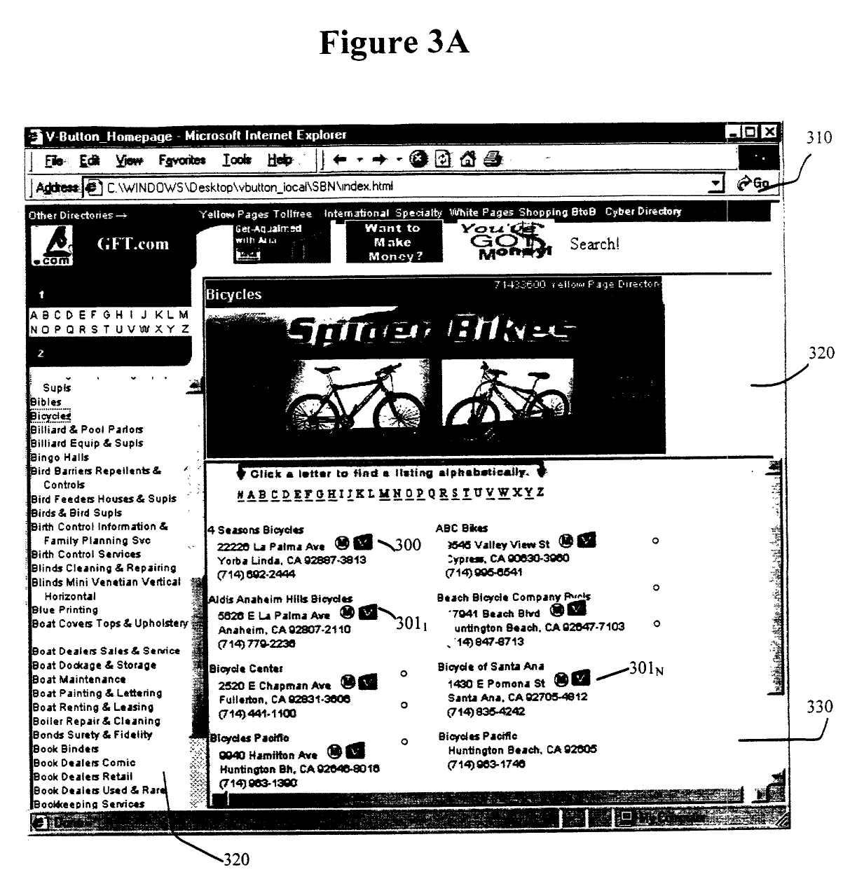

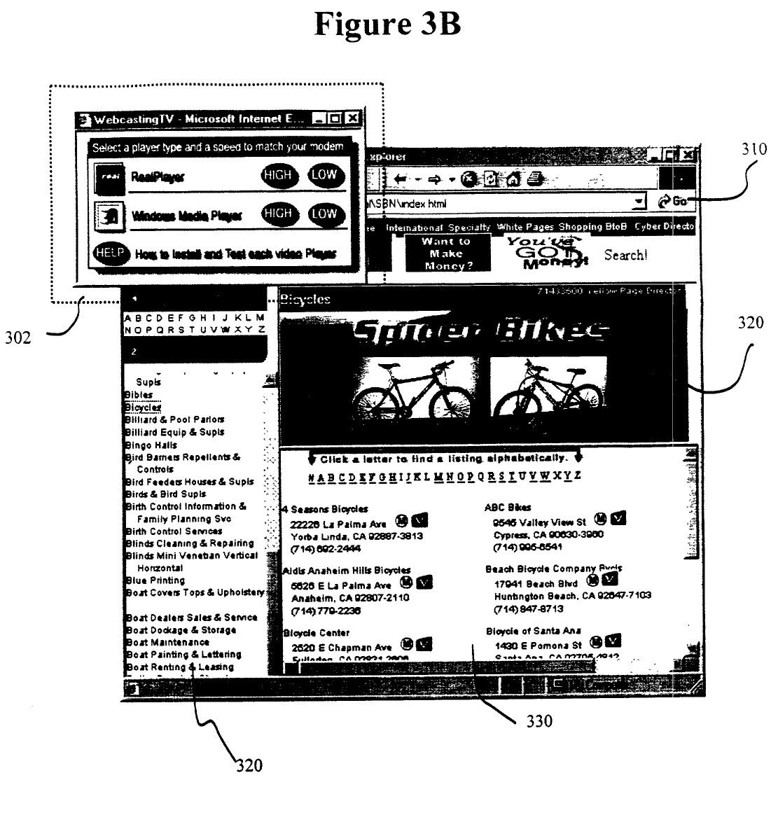

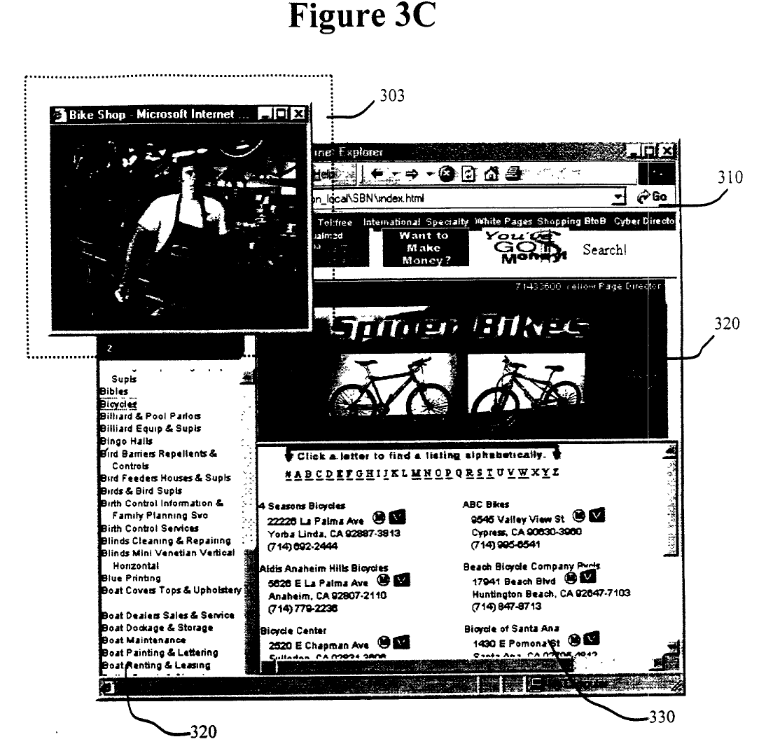

FIG. 3A depicts one embodiment of a display screen 310 of an online directory which has subscribed to the video linking service. In one embodiment the online directory is one of the target Websites 50₁-50_{NN}. FIG. 3A comprises a display screen 310, a graphics portion 320, a listings portion 330, active video icons 300, and inactive video icons 301₁-301_{N}. In one embodiment, the video icons are V-Buttons, as depicted in FIG. 3A. It should be appreciated that such directories can be downloaded or otherwise transferred to an offline storage medium, such as a handheld computer. It should further be appreciated that video icons can be associated with online banner advertisements, rather than merely directory entries as is depicted in FIG. 3A. It should further be appreciated that the video icon can vary in form and shape.

The online directory can be a specialty directory where its listings are specific to a given category, or general directories, as are familiar to those skilled in the art. It should be appreciated that directories can subscribe to the video linking service on an all-or-nothing basis in which all directory entries are accompanied by a video icon, or directories can subscribe on a more limited basis, where only selected entries are accompanies by a video icons.

FIG. 3B depicts one embodiment of the online directory of FIG. 3A after a user has selected one of the video icons. Where the user's preference for media player is unavailable, a graphical dialog box 302 is presented to the user for selection of a particular media player type. It should be appreciated that graphical dialog box 302 may be a popup window, as is depicted, or it may be a separate Webpage. It should further be appreciated that the user's media player preference can be stored on server 22, database 24, or, as is familiar to those skilled in the art, a cookie can be sent to the user's computer 40, which can later be identified by software on the developer's server 22. Thus, the next time the user presses any video icon located on any Website subscribing to the video linking service, the user's preference will be queried either from the stored cookie or from user data stored on server 22 or database 24.

FIG. 3C illustrates one embodiment of the display page of FIG. 3A after a user has selected an active video icon and after the user's media player preference has been determined, as discussed above. It should be appreciated that the video 303 can include both audio and textual components, such as surrounding banner advertisements. It should further be appreciated that video 303 can be in the form of a popup window, as is depicted in FIG. 3C or on a separate Webpage. It should further be appreciated that video 303 can be streamed from server 22 or database 24, as well as from any one of target Websites 50₁-50_{NN}.

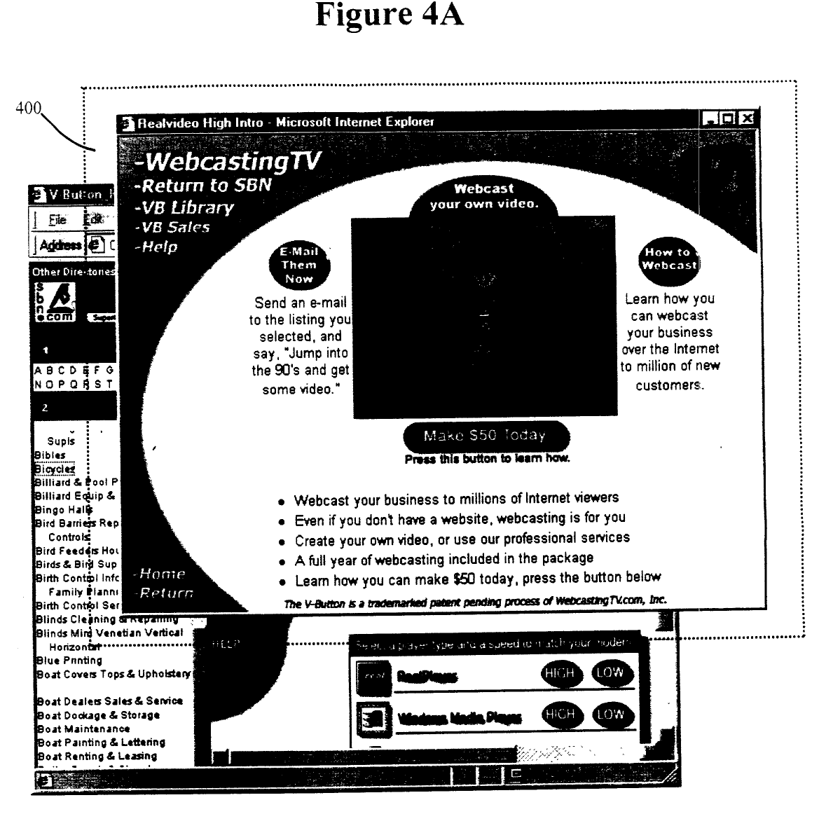

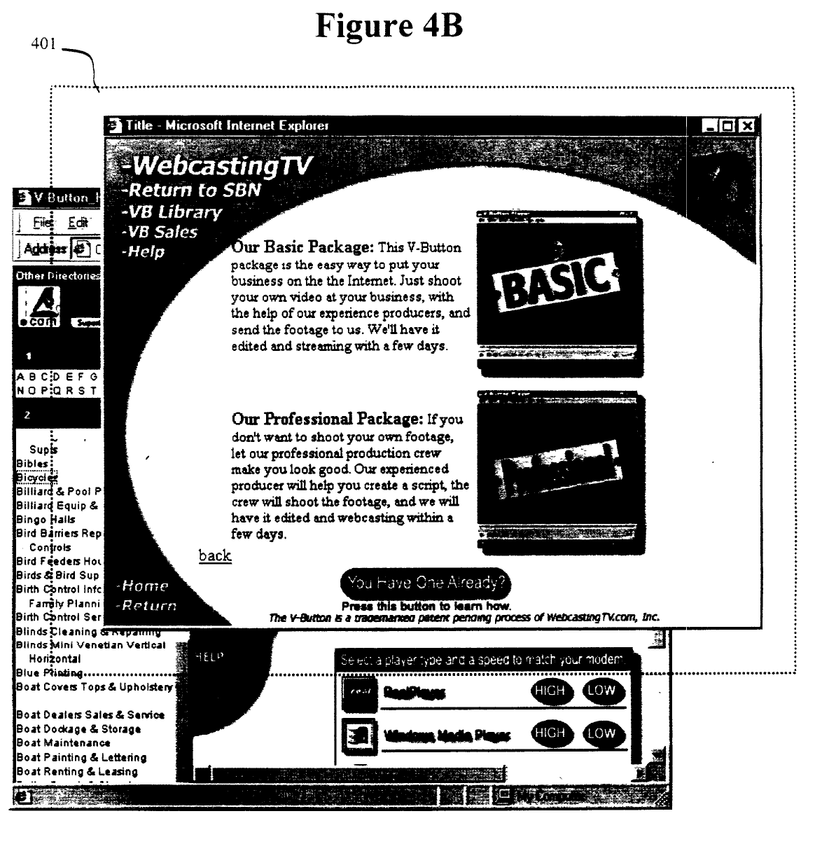

FIG. 4A illustrates one embodiment of the display page of FIG. 3A after the user has selected an inactive video icon. In this embodiment, the user is presented with graphical dialog box 400 in the form of a popup window. It should be appreciated that graphical dialog box 400 can also be on a separate Webpage. Graphical dialog box 400 is designed to provide the user with more information on how to activate the V-Button by having it linked to a video file.

As another embodiment of FIG. 4A, FIG. 4B illustrates the display page of FIG. 3A after the user has selected an inactive V-Button. In this embodiment, the user is presented with graphical dialog box 401 in the form of a popup window. It should be appreciated that graphical dialog box 401 can also be on a separate Webpage. Graphical dialog box 401 is designed to provide the user with more information on how to subscribe to the video linking service. It should further be appreciated that graphical dialog box 401 can be included in place of graphical dialog box 400 or in addition thereto. It should further be appreciated that, upon clicking an inactive video icon, a user may obtain activation information by being directed to another Website or by requesting that information be sent through email, telephone, postal service, or any other method of receiving information of the type contemplated in this embodiment.

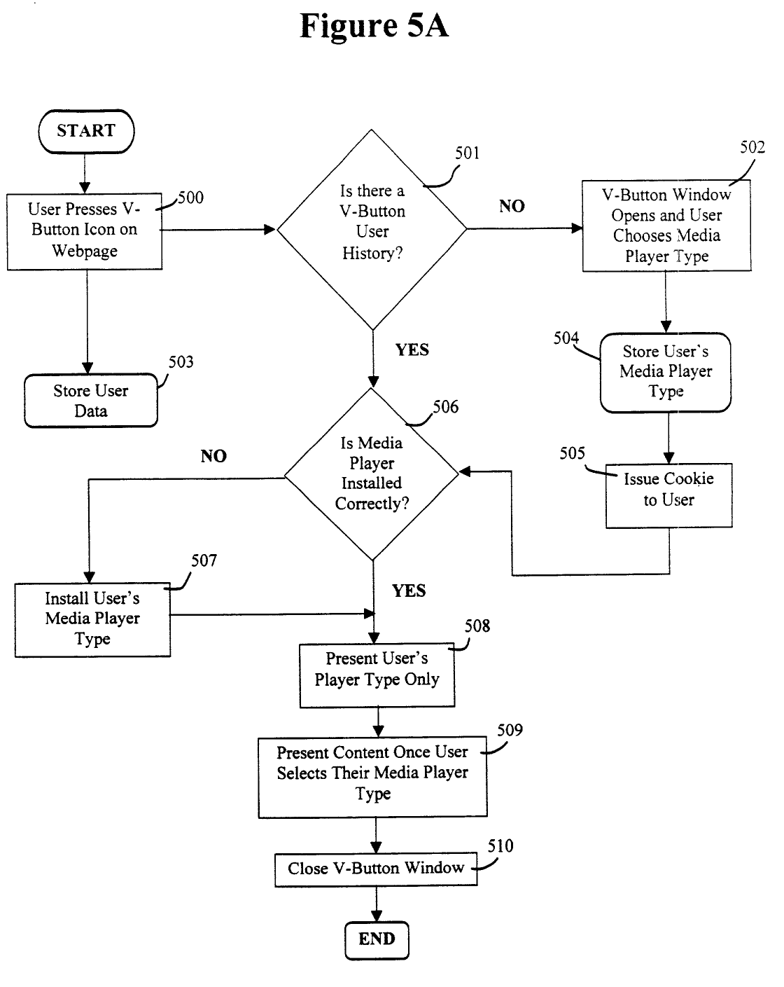

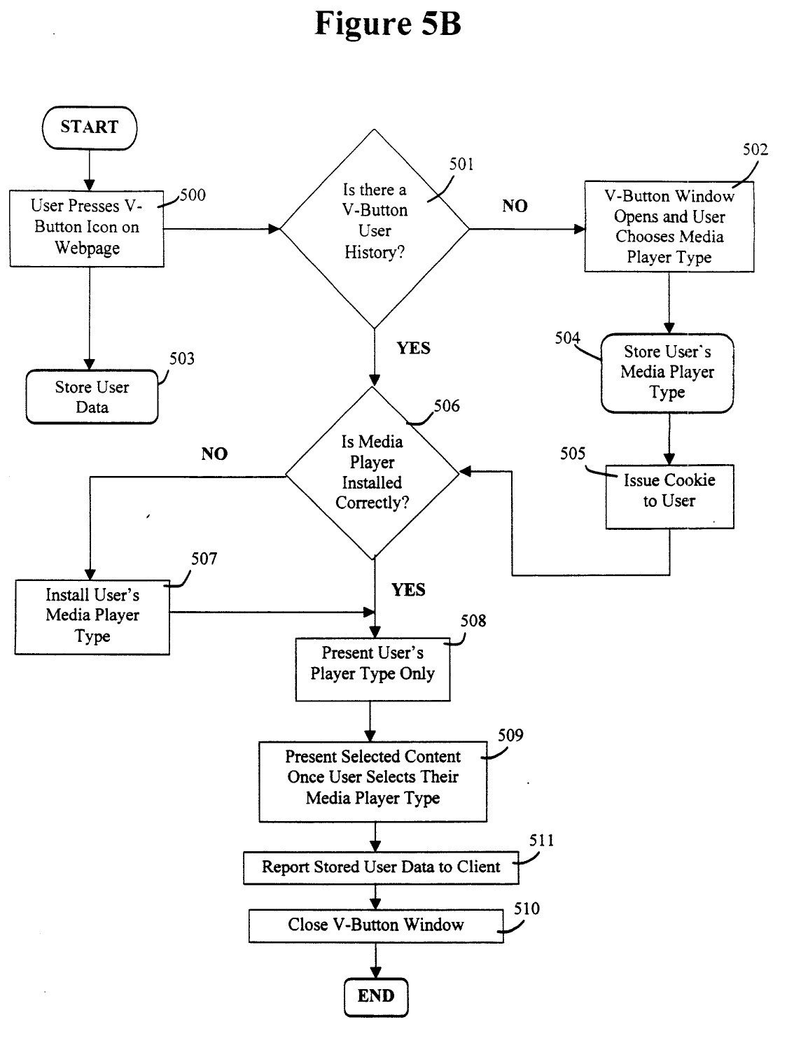

FIG. 5A is a block/flow diagram for the process of viewing streaming video, according to one embodiment of the present invention. Referring to FIG. 5A, a user, at process block 500, presses an active video icon which is located on a Webpage which triggers decision block 501. At block 501, a determination is made as to whether there is any available information on the user's media player preference. In one embodiment, this involves software on server 22 or database 24 looking for the presence of a cookie, as understood by one skilled in the art, on the user's computer 40. In yet another embodiment, block 501 involves software on server 22 or database 24 retrieving data located on server 22 or database 24 indicated the user's media player preference. Data relating to the user's media player preference can be collected in any manner commonly known to those skilled in the art. For example, one embodiment of the present invention has software on server 22 or database 24 retrieving the user's Internet Protocol Address which has been assigned to their computer 40. This number is stored in a database cross-referenced with data relating to the user's media player preference. At block 502, the graphical dialog box 302 opens for the user to choose a media player. If decision block 501 returned a null string, then all available media players will be displayed. The selected media player is then stored as discussed above and a cookie representing this media player type is issued to the user's computer. In another embodiment, this media player type data is stored on server 22 or database 24.

On the other hand, if block 501 returned a valid value, then software on server 22 or database 24 checks to see if the media player is correctly installed. If not, then in one embodiment, the user is directed to a Website from which the user may download the media player. It should be appreciated that the media player can be installed directly from server 22 or database 24, or from any other computer-readable medium.

Once the system has determined that the user's preferred player is properly installed (block 506), the user is presented with that media player type (block 508). The user is then presented with the content to be played in the selected media player (block 509). It should be appreciated that, once block 506 determines the media player of choice is correctly installed, blocks 508 and 509 can be combined into one block reflecting the fact that the media player and the video content selected via the V-Button is simultaneously presented to the user.

It should further be appreciated that in one embodiment of the present invention, information relating to the user's online location (i.e. which Website or online directory they are at), user's video file selection, IP Address, and any other available online information is recorded and stored (block 503). This data can be stored at server 22 or database 24. It should further be appreciated that this data can be stored on the target website 50.

FIG. 5B relates to one embodiment of the block/flow diagram of FIG. 5A. In this embodiment, the data collected at process block 503 is formatted by converting it to a database or spreadsheet form. This data is then reported or otherwise sent to the client at block 511, where the client may be one of any merchant, service provider or other business, or where the client may also include the target Websites 50. In yet another embodiment, this user data may be disseminated to direct marketing firms, data-mining firms, or others who may have some proprietary interest in such data.

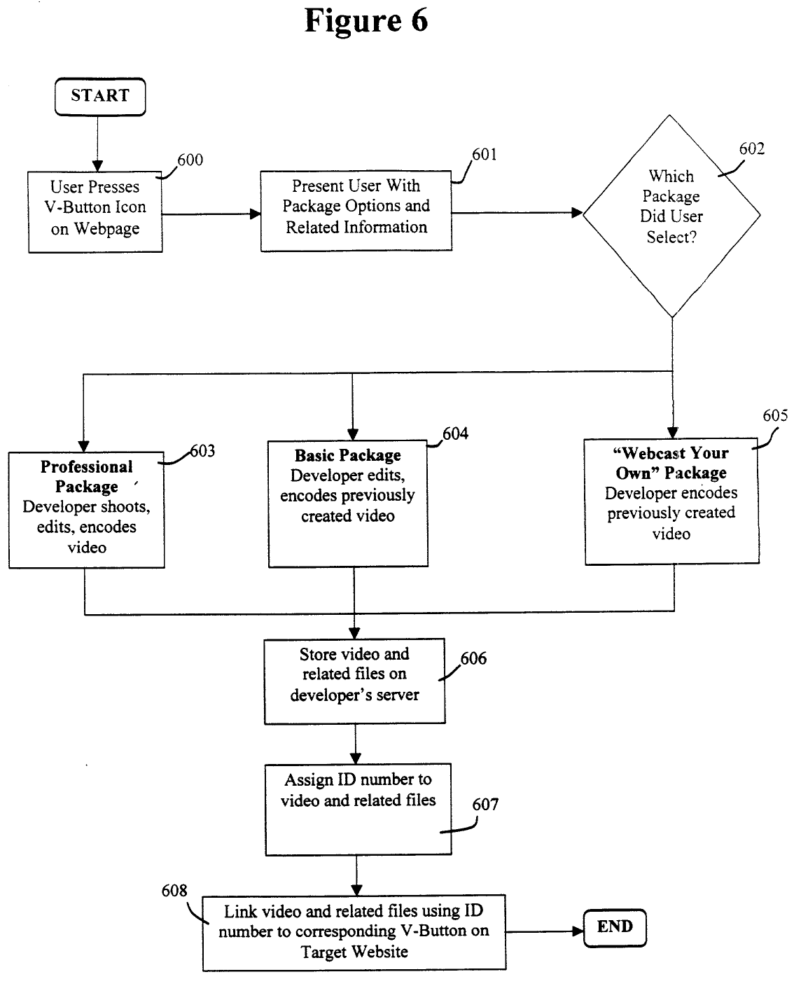

FIG. 6 illustrates a block/flow diagram for one embodiment of the process of creating and making available streaming video, according to one embodiment of the present invention. Referring to FIG. 6, a user at block 600 presses an inactive video icon on a Webpage. A display screen, of the type depicted in FIG. 4A and/or FIG. 4B, is displayed to the user at block 601. In the present embodiment, the user selects from the available options by indicating which “package” they would like to purchase. Software at server 22 or database 24 records this information (blocks 603-605). Where the “Professional Package” is selected, the developer creates the video using video equipment common in the art. Where either the “Basic Package” or “Webcast Your Own Video Package” is selected, the user sends the video to the developer. In any case, the video is digitized, compress, and encoded to enable it to be played on all of the common commercial media players. The video file and all related files are then stored on server 22 or database 24 (block 606). Once the appropriate files are stored, one embodiment has these files being assigned a client Identification Number. Software on server 22 or database 24 can then be used to link the V-Button to the corresponding video files. It should be appreciated that any commonly known means of linking an icon to files located on a server connected to a network, as in network system 10, can be used.

In yet another embodiment, merchants, service providers and the like, desiring to link a directory entry corresponding to their business to a video file, may select a video linking service package as described in FIGS. 4A, 4B, and 6. Upon selection of the video linking service package, software on server 22 or database 24 will enable the user to submit a video clip to server 22 or database 24 using their computer 40 and network system 10. In one embodiment, upon receipt of this video clip, software on server 22 or database 24 is capable of processing the clip, generating any necessary support files, and assigning it an identification number which will then be used to establish a link between the video clip and the corresponding video icon. As described in previous sections, this link will ‘activate’ the video icon allowing subsequent users to be able to select the video icon and view the corresponding video material on the media player of their choice. While the aforementioned embodiment describes a fully automated system for submitting video files over a network to be processed and linked to corresponding video icons, it should be appreciated that the processing software on server 22 or database 24 may prompt the developer during the processing phase. Such prompt may be to review the video file content to determine the appropriateness of the material, or may be to perform additional editing and/or manual processing.

In yet another embodiment, video clips may be encrypted by the user before being submitted to server 22 or database 24 via network system 10. In this embodiment, the encrypted video clip will then be decrypted by software on server 22 or database 24. In yet another embodiment, video files submitted over the network system 10 will be ‘filtered’ by filtering software on server 22 or database 24. Such filtering software will be of the type known to those skilled in the art and will be capable of scanning video clips for inappropriate content.

It should further be appreciated that whether the video submission process is automated (i.e. takes place over network system 10) or manual (i.e. takes place outside of network system 10), the method for payment for the selected video linking service package may be accomplished online via the network system 10 communications link. Such a system will comprise the commonly known features of e-commerce as known to those skilled in the art, including, but not limited to, such features as information encryption and credit card verification.

What is claimed is:

1. A method for providing multimedia content to a user over a network comprising:
providing, to a user computer, an icon adjacent to a directory entry where said directory entry is to be included in a plurality of directories that are accessible over said network;
determining if the user has indicated a preferred file format, if not, requesting that the user indicate the preferred file format; and, providing said multimedia content to the user computer in response to said user selection of said icon, said multimedia content to be provided to the user computer in the preferred file format.

2. The method of claim 1, wherein said network is the Internet and the multimedia content includes a digitized video clip.

3. The method of claim 1, wherein said icon is a hypertext link that, when selected, accesses said multimedia content, said multimedia content to be stored on a server that is connected to said network.

4. The method of claim 1, wherein providing, to said user computer, the icon adjacent to the directory entry comprises providing, to said user computer, the icon adjacent to the directory entry using an Internet browser that is displaying one of said plurality of directories containing contact information for a plurality of commercial entities.

5. The method of claim 1, wherein requesting that the user indicate the preferred file format comprises: displaying a plurality of format options in a separate occurrence of the Internet browser on said user computer in response to the user selecting said icon, and transmitting a cookie file to the user computer indicating the preferred file format.

6. The method of claim 1, wherein providing said multimedia content to the user computer in response to said user selection of said icon comprises streaming, to a separate occurrence of the Internet browser on the user computer, said multimedia content.

7. The method of claim 1, further comprising determining if the user computer includes a media player capable of displaying said preferred file format and, if not, providing said user with a hypertext link for downloading said media player over said network.

8. A system for providing multimedia content to a user over a network comprising:
a memory for storing instruction sequences;
a processor coupled to said memory, the processor to execute the stored instructions sequences;
wherein the stored instruction sequences cause the processor to (a) provide, to a user computer, an icon adjacent to a directory entry where said directory entry is to be included in a plurality of directories that are accessible over said network; (b) determine if the user has indicated a preferred file format, if not, request that the user indicate the preferred file format; and (c) provide said multimedia content to the user computer in response to said user selection of said icon, said multimedia content to be provided to the user in the preferred file format.

9. The system of claim 8, wherein said network is the Internet and the multimedia content includes a digitized video clip.

10. The system of claim 8, wherein said icon is a hypertext link that, when selected, causes an access of said multimedia content, said multimedia content to be stored on a server that is connected to said network.

11. The system of claim 8, wherein in (a), said directory entry and said icon are provided, to said user computer, using an Internet browser that is displaying one of said plurality of directories containing contact information for a plurality of commercial entities.

12. The system of claim 8, wherein in (b), requesting that the user indicate the preferred file format comprises: displaying a plurality of format options in a separate occurrence of the Internet browser on said user computer in response to the user selecting said icon, and transmitting a cookie file to the user computer indicating the preferred file format.

13. The system of claim 8, wherein in (c), providing said multimedia content to the user computer in response to said user selection of said icon comprises streaming, to a separate occurrence of the Internet browser on the user computer, said multimedia content.

14. The system of claim 8, wherein the stored instruction sequences further cause the processor to (d) determine if the user computer includes a media player capable of displaying said preferred file format and, if not, providing said user with a hypertext link for downloading said media player over said network.
